(19) United States
(12) Patent Application Publication
(10) Pub. No.: US 2009/0031595 A1
(43) Pub. Date: Feb. 5, 2009

(54) ON-LINE LOTTERY GREETING CARD

(75) Inventors: Michael A. Dolan, Cleveland, OH (US); Gwendolyn A. Penn, Cleveland, OH (US); Patricia Vasil, North Royalton, OH (US)

Correspondence Address: FAY SHARPE LLP, 1100 SUPERIOR AVENUE, SEVENTH FLOOR, CLEVELAND, OH, 44114, US

(73) Assignee: Ohio Lottery Commission

(21) Appl. No.: 12/121,436

(22) Filed: May 15, 2008

Related U.S. Application Data
(60) Provisional application No. 60/930,370, filed on May 16, 2007.

(51) Int. Cl. G09F 1/04; A63F 9/24

(52) U.S. Cl. 40/124.01; 463/17

(57) ABSTRACT

This disclosure provides an on-line greeting card, on-line greeting card system and method of operating an on-line greeting card system. The on-line greeting card includes a greeting printed on one or more faces and one or more lottery numbers printed on one or more faces. A recipient of the greeting card enters the one or more lottery numbers into a field associated with a website to determine if the lottery numbers are associated with a prize.

This applications claims priority to and the benefit of U.S. Application Ser. No. 60/930,370, filed May 16, 2007, the disclosure of which is totally incorporated by reference herein.

### BACKGROUND

This invention relates to a lottery greeting card. Specifically, this invention relates to an on-line lottery greeting card and will be described with particular reference thereto. However, it is to be appreciated that the present exemplary embodiment is also amenable to other like applications.

### BRIEF DESCRIPTION

In one embodiment of this disclosure, an on-line lottery greeting card is disclosed. The on-line greeting card comprises a greeting printed on one or more faces of the greeting card and directed to one or more recipients of the greeting card; and one or more lottery numbers printed on one or more faces of the greeting card, wherein the one or more lottery numbers are entered into a website to determine if the lottery numbers are associated with a prize.

In another embodiment of this disclosure, an on-line greeting card system is disclosed. The on-line greeting card system comprises a greeting card comprising one or more lottery numbers and a unique identifier; and a website associated with the greeting card, wherein a user of the on-line greeting card system enters the one or more lottery numbers into a field associated with the website to determine if the lottery numbers are associated with a prize.

In another embodiment of this disclosure, a method of operating an on-line lottery greeting card system is disclosed. The method comprises a) scanning a greeting card comprising a unique identifier and one or more lottery numbers; b) accessing an administrative database to activate the greeting card for a lottery game; and c) providing a website for a recipient of the card to enter the one or more lottery numbers and determine if a prize is associated with the card.

### BRIEF DESCRIPTION OF THE DRAWINGS

FIG. 1A illustrates the front and back of a lottery greeting card according to one exemplary embodiment of this disclosure.

FIG. 1B illustrates the inside left and inside right of a lottery greeting card according to one exemplary embodiment of this disclosure.

FIG. 2 illustrates a method of operating an on-line lottery greeting card system according to one exemplary embodiment of this disclosure.

FIG. 3 illustrates an on-line lottery greeting card system according to one exemplary embodiment of this disclosure.

### DETAILED DESCRIPTION

Substantively, the disclosed on-line lottery greeting card system and method operates as follows:

Initially, a customer selects a lottery greeting card which includes a specific greeting or message appropriate for the receiver of the card. In addition, the card includes a unique number and the card includes one or more series of lottery numbers printed on the card. For example, the card may include a unique SKU number which is bar coded.

After selection of an appropriate card, the customer proceeds to a check-out area where the card is paid for along with any other items purchased at the retail location. During the check-out process, the lottery greeting card is scanned by an electronic bar code reader, where for example, the lottery greeting card SKU number is read by the electronic bar code reader and an operatively connected controller/scanner system.

After the customer has paid for the lottery greeting card, an activation process is initiated by the controller/scanner system used for check-out. The initiated activation process may include another computer system operatively connected to the check-out controller/scanner system. In addition, the controller/scanner system may be operatively connected to an inventory control system to account and maintain an inventory of lottery style greeting cards.

To activate the lottery greeting card for play, the controller/scanner system or other operatively connected computer system transmits the lottery greeting card's unique number to an administration controller which verifies the number is a valid lottery greeting card identifier. After the unique number has been authenticated, the administrator controller activates the lottery numbers associated with the card.

At this point, the lottery greeting card has been purchased and the card has been activated. Notably, transmission of the card unique number, e.g. SKU number, from the card point of sale location to the administrative controller may include any means for remote data transmission currently known or developed in the future. For example, the unique number may be transmitted to the administrative controller via the internet and/or a dedicated communication line. In addition, the data communication may include wireless data transmissions.

To play the lottery greeting card, the receiver of the card follows instructions printed out on the card. These instructions provide a website address for the card recipient to access via the internet. The web site address provides a web page which provides information and data fields related to determining if the lottery greeting card is a winner. In addition, the web page can be tailored to the specific greeting card style, for example a display related to birthdays for a “Happy Birthday” greeting card. After accessing the card website address, the card recipient types in the lottery numbers printed on the card to determine if he or she is a winner of a prize associated with the lottery. The prize may include anything of value, for example cash, automobile, trip, etc.

As will be understood by those of skill in the art of lottery gaming, various methods and systems can be used to utilize the on-line lottery greeting card method and systems disclosed. It is to be understood the embodiments described are merely embodiment examples and variations of these embodiments are within the scope of this disclosure.

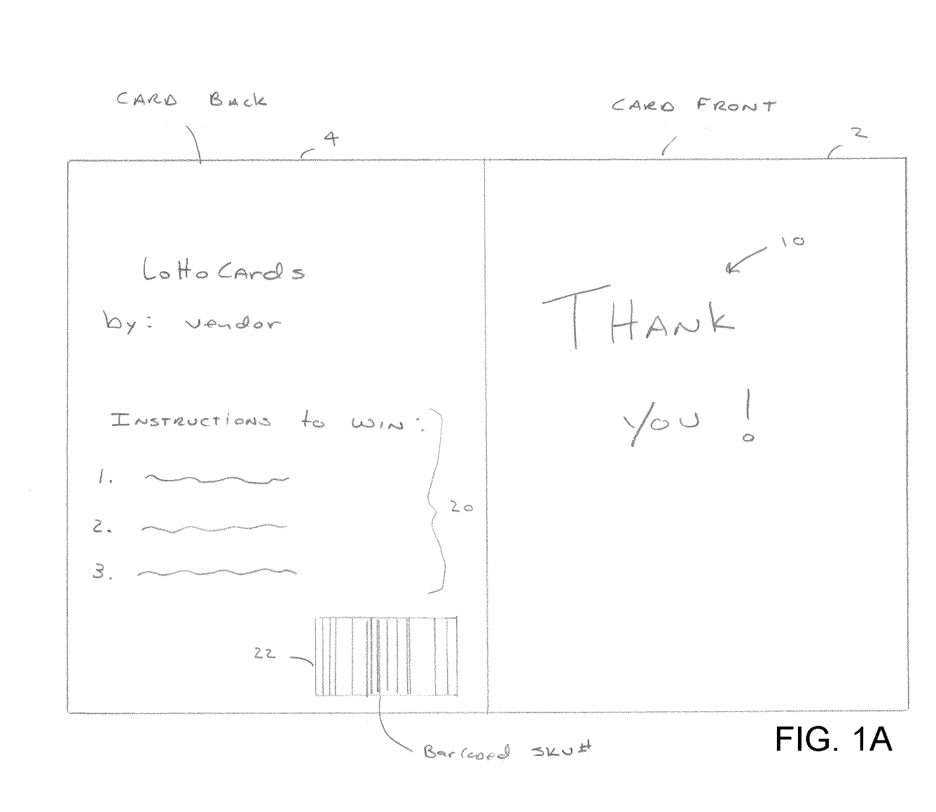

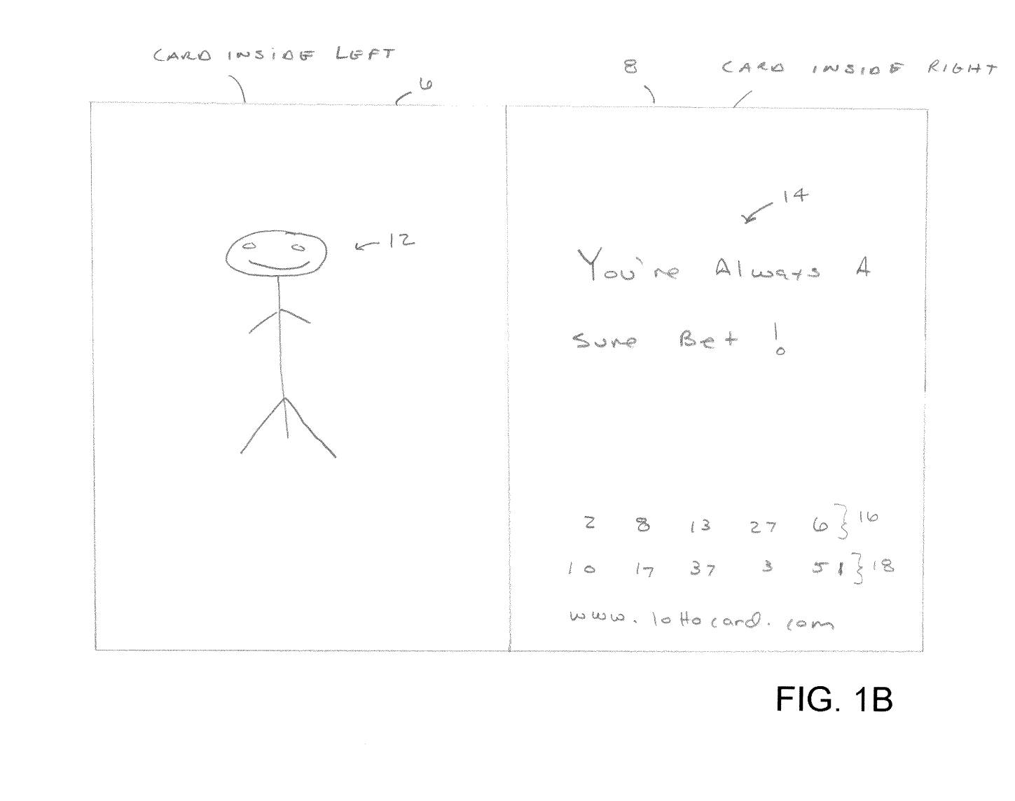

With reference to FIGS. 1A and 1B, illustrated is a lottery greeting card according to one exemplary embodiment of this disclosure.

The lottery greeting card includes a front 2, a back 4, a left inside 6 and a right inside face 8.

The front face 2 includes a greeting and/or salutation 10 appropriate for a receiver of the card, for example “Thank you!”

The left inside 6 and right inside 8 faces include additional printing 12, 14 intended for the recipient, for example a drawing/picture 12 or personal communication 14 from the sender to the recipient such as “You're Always a Sure Bet!”

In addition to the greeting card text/pictures printed on the left and right inside card faces, the exemplary embodiment of this disclosure includes two series of lottery numbers, 16 and 18, printed on the right inside card face. The first lottery number sequence 16 is “2 8 13 27 6” and the second lottery number sequence 18 is “10 17 37 3 51.”

Instructions 20 directed to the recipient of the card for playing the lottery game associated with the card are printed on the back face of the card. For example, the instructions may include an internet web address for a recipient of the greeting card to access to determine if she/he is a winner. Other instructions may include specific procedures for entering the lottery numbers into a field displayed on a web page associated with the internet web address. In addition, a bar coded SKU number 22 may be printed on the card back to enable a cashier to scan the card.

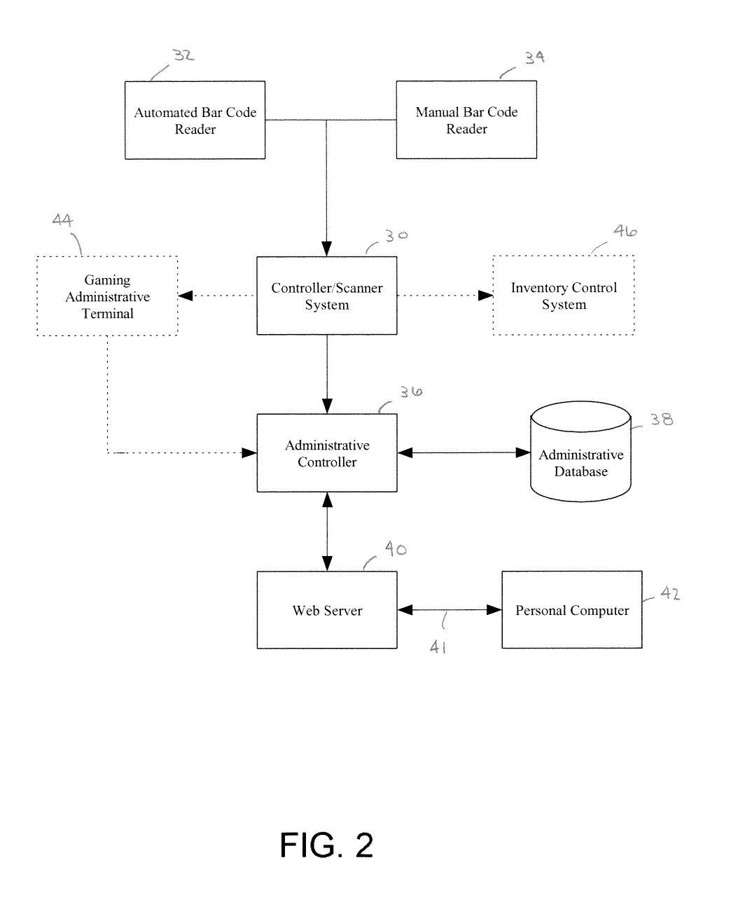

With reference to FIG. 2, illustrated is an exemplary embodiment of an on-line lottery greeting card system according to this disclosure. The system includes a controller/scanner system 30, an automatic bar code reader 32, a manual bar code reader 34, an administrative controller 36, an administrative data base 38, a web server 40, an internet communication line(s) 41 and a personal computer (PC) 42 for a recipient of a lottery greeting card to access the system. In addition, a gaming administrative terminal 44 and an inventory control system 46 may be operatively connected to the system whereby the functions of inventory control and activation of a lottery greeting card are performed independently.

All hardware illustrated and described with reference to FIG. 2 is commercially available and known to those of ordinary skill in the art.

The bar code readers 32 and 34, and the operatively connected controller/scanner system is commonly found at retail point of sale locations to scan items to be purchased, such as groceries, clothes, tools, etc. Moreover, the optional inventory control system associated with the on-line lottery greeting card system is commonly found at these retail point of sale locations.

The optional gaming administrative terminal 44 is also commercially available and known to those of ordinary skill in the art. For example, current state lottery systems typically use an independent gaming administrative terminal to print and record purchased lottery tickets.

The administrative controller 36, which will typically be located offsite of the point of sale location, may be any computer/server capable of executing software to interface with an internal/external administrative database 38 and internet web server 40. The administrative controller 36 hardware/software are configured to communicate with one or more of the gaming administrative terminal 44 and the controller/scanner system 30 to validate and activate lottery greeting cards purchased at the point of sale location. The operatively connected administrative database 38 provides the necessary data storage for electronically storing, activating and authenticating lottery numbers associated with the lottery greeting cards.

The web server 40, internet communication link 41 and personal computer 42 are commonly used and available for typical internet activity.

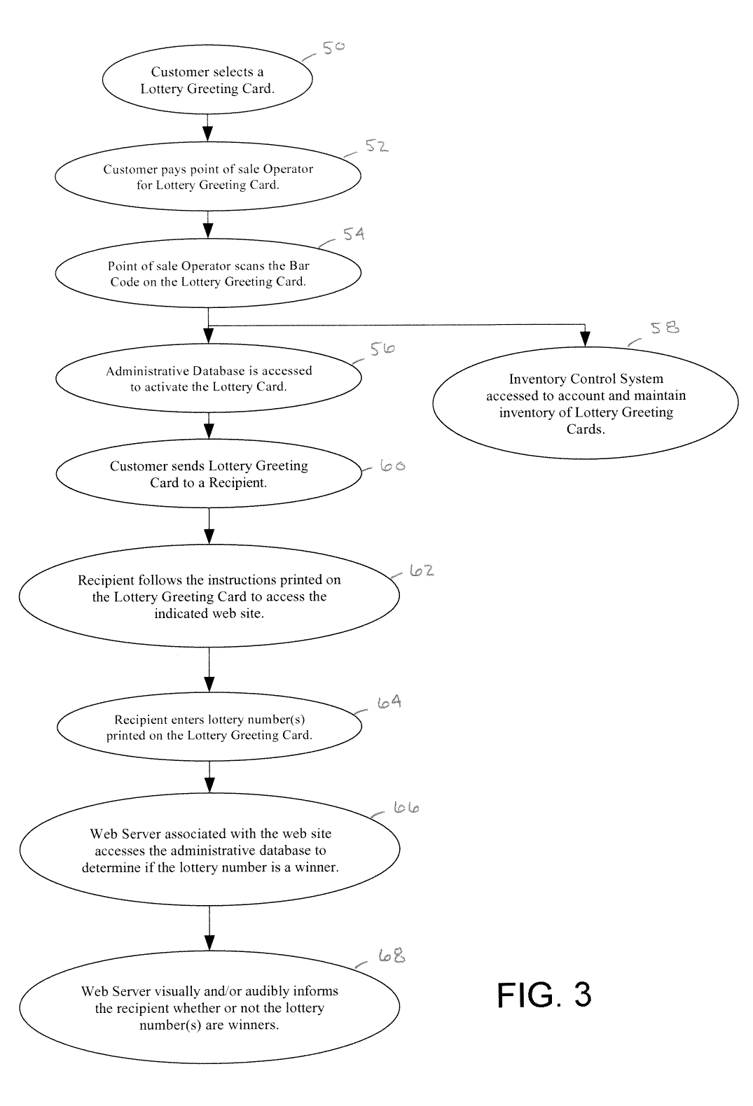

With reference to FIG. 3, illustrated is an exemplary method of operating an on-line lottery greeting card system as disclosed. As will be apparent to those of ordinary skill in the art, this method may be varied while still substantively providing a lottery greeting card operation and these variations are within the scope of this disclosure.

The illustrated exemplary method operates as follows:

Initially, a customer selects 50 a lottery greeting card.

Next, the customer pays 52 the point of sale operator for the lottery greeting card.

Next, the point of sale operator scans 54 a bar code on the lottery greeting card for activation by an administrative controller.

Next, the administrative controller accesses 56 an administrative database to activate the lottery greeting card. Notably, at step 58, an inventory control system may also be accessed to account and maintain the inventory of the lottery greeting cards and any other items associated with the point of sale location.

Next, the customer, i.e. purchaser of the card, sends 60 the lottery greeting card to a recipient.

Next, the recipient receives the lottery greeting card and follows 62 the instructions printed on the lottery greeting card to access the indicated website.

Next, the recipient enters 64 the lottery number(s) printed on the lottery greeting card into a field displayed on the website.

Next, the web server associated with the website accesses 66 the administrative database to determine if the lottery number is a winner.

Finally, the web server, visually and/or audibly informs 68 the recipient whether or not they are winners and entitled to a prize.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An on-line lottery greeting card comprising:
a greeting printed on one or more faces of the greeting card; and
one or more lottery numbers printed on one or more faces of the greeting card, wherein the one or more lottery numbers are entered into a website to determine if the lottery numbers are associated with a prize.

2. The on-line lottery greeting card according to claim 1, further comprising:
a bar coded SKU number printed on one or more faces of the greeting card.

3. The on-line lottery greeting card according to claim 1, wherein the one or more lottery numbers are entered into a website tailored to the specific greeting associated with the card.

4. The on-line lottery greeting card according to claim 1, further comprising:
instructions printed on one or more faces of the greeting card to instruct a recipient of the greeting card how to determine if the lottery numbers are associated with a prize.

5. The on-line lottery greeting card according to claim 1, further comprising:
a bar coded SKU number printed on one or more faces of the greeting card; and
instructions printed on one or more faces of the greeting card to instruct a recipient of the greeting card how to determine if the lottery numbers are associated with a prize.

6. An on-line lottery greeting card system comprising:
a greeting card comprising one or more lottery numbers and a unique identifier;
a website associated with the greeting card, wherein a user of the on-line greeting card system enters the one or more lottery numbers into a field associated with the website to determine if the lottery numbers are associated with a prize.

7. The on-line lottery greeting card system according to claim 6, further comprising:
an administrative database; and
a point of sale scanner operatively connected to the administrative database;
wherein the system is configured to scan the card unique identifier and activate the lottery numbers associated with the card.

8. The on-line lottery greeting card system according to claim 6, wherein the unique identifier is a SKU number.

9. An on-line lottery greeting card system according to claim 7, further comprising:
a gaming administration terminal operatively connected to the administrative database, wherein the point of sale scanner is operatively connected to the gaming administration terminal.

10. An on-line lottery greeting card system according to claim 9, further comprising:
an inventory control system operatively connected to one or more of the point of sale scanner, the gaming administration terminal and the administrative database.

11. An on-line lottery greeting card system according to claim 7, further comprising:
a web server operatively connected to the administrative database, the web server configured to provide the website.

12. A method of operating an on-line lottery greeting card system comprising:
a) scanning a greeting card comprising a unique identifier and one or more lottery numbers;
b) accessing an administrative database to activate the greeting card for a lottery game; and
c) providing a website for a recipient of the card to enter the one or more lottery numbers and determine if a prize is associated with the card.

13. The method of operating an on-line lottery greeting card system according to claim 12, wherein the unique identifier comprises a SKU number.

14. The method of operating an on-line lottery greeting card system according to claim 13, wherein the website is tailored to a greeting associated with the card.

15. The method of operating an on-line lottery greeting card system according to claim 12,
accessing an inventory control system after step a).

16. The method of operating an on-line lottery greeting card system according to claim 12, wherein the unique identifier comprises a bar code.

17. The method of operating an on-line lottery greeting card system according to claim 16, wherein step a) comprises scanning the greeting card with a bar code reader.

18. The method of operating an on-line lottery greeting card system according to claim 12, wherein step c) comprises a user accessing a web server to access the website.

19. The method of operating an on-line lottery greeting card system according to claim 12, further comprising:
d) a user accessing the website;
e) the user entering the one or more lottery numbers in one or more respective fields of the website;
f) the website accessing the administrative database to determine if the one or more lottery numbers are associated with a prize; and
g) the website communicating to the user whether or not one or more of the lottery numbers are prize winning lottery numbers.

20. The method of operating an on-line lottery greeting card system according to claim 19, wherein step g) comprises one or more of visual communicating to the user and audibly communicating to the user.
